(19) United States
(12) Patent Application Publication
(10) Pub. No.: US 2014/0185713 A1
(43) Pub. Date: Jul. 3, 2014

(54) OFDM RECEIVER AND OFDM COMMUNICATIONS SYSTEM

(71) Applicant: SAMSUNG ELECTRO-MECHANICS CO., LTD., Suwon (KR)

(72) Inventor: Jae Wook KWON, Suwon (KR)

(73) Assignee: SAMSUNG ELECTRO-MECHANICS CO., LTD., Suwon (KR)

(21) Appl. No.: 13/844,193

(22) Filed: Mar. 15, 2013

(30) Foreign Application Priority Data
Dec. 27, 2012 (KR) 10-2012-0155298

(51) Int. Cl. H04L 27/26

(52) U.S. Cl. CPC H04L 27/265
USPC 375/340

(57) ABSTRACT

There is provided an OFDM receiver including, a wireless communications unit receiving a transmission signal including wireless data information and pilot information, a signal dividing unit dividing the transmission signal into a plurality of division signals and obtaining frequency offsets for the respective division signals based on the pilot information included in the transmission signal, and a demodulating unit demodulating the transmission signal based on the division signals and the frequency offsets.

### CROSS-REFERENCE TO RELATED APPLICATIONS

This application claims the priority of Korean Patent Application No. 10-2012-0155298 filed on Dec. 27, 2012, in the Korean Intellectual Property Office, the disclosure of which is incorporated herein by reference.

### BACKGROUND OF THE INVENTION

1. Field of the Invention

The present invention relates to an orthogonal frequency division multiplexing (OFDM) receiver and an OFDM communications system capable of decreasing inter-channel interference generated due to the Doppler Effect.

2. Description of the Related Art

Recently, due to the appearance of smartphones and tablet personal computers (PCs), demand for wide band wireless transmissions has rapidly increased. Therefore, technologies such as mobile Wimax and long term evolution (LTE) have appeared, and orthogonal frequency division multiplexing (OFDM) technology has been used in order to transmit data at high speeds.

OFDM technology shows rapid transmission speeds and high frequency efficiency in a multipath fading environment. In addition, a structure of an equalizer is simplified, such that the entire communications system may be simplified.

However, since an inter-channel interference (ICI) may be generated in a moving environment due to the Doppler effect, performance of an OFDM system may be deteriorated.

Therefore, a configuration for preventing deterioration in the performance of an OFDM system due to the Doppler Effect is required.

The following Related Art Document (Patent Document 1), which relates to an OFDM receiving circuit having a plurality of demodulation paths, does not disclose a configuration for decreasing inter-channel interference generated due to the Doppler effect.

### RELATED ART DOCUMENT

### Patent Document

(Patent Document 1) Korean Patent Laid-Open Publication No. 2008-0077341

### SUMMARY OF THE INVENTION

An aspect of the present invention provides an orthogonal frequency division multiplexing (OFDM) receiver and an OFDM communications system, capable of preventing deterioration in performance of an OFDM system due to the Doppler Effect.

According to an aspect of the present invention, there is provided an orthogonal frequency division multiplexing (OFDM) receiver including: a wireless communications unit receiving a transmission signal including wireless data information and pilot information; a signal dividing unit dividing the transmission signal into a plurality of division signals and obtaining frequency offsets for the respective division signals based on the pilot information included in the transmission signal; and a demodulating unit demodulating the transmission signal based on the division signals and the frequency offsets.

The demodulating unit may include a serial-to-parallel converter converting the division signals into parallel signals.

The demodulating unit may include a fast Fourier transformer performing a fast Fourier transform on the parallel signals based on the frequency offsets.

The demodulating unit may include a parallel-to-serial converter converting a signal output from the fast Fourier transformer into a serial signal.

The OFDM receiver may further include a combining unit combining the demodulated signals with one another.

According to another aspect of the present invention, there is provided an OFMD communications system including: a transmitter transmitting a transmission signal including wireless data information and pilot information; and a receiver receiving the transmission signal, wherein the receiver divides the transmission signal into a plurality of division signals and obtains frequency offsets for the respective division signals based on the pilot information included in the transmission signal.

The receiver may include a demodulating unit demodulating the transmission signal based on the division signals and the frequency offsets.

The demodulating unit may include a serial-to-parallel converter converting the division signals into parallel signals.

The demodulating unit may include a fast Fourier transformer performing a fast Fourier transform on the parallel signals based on the frequency offsets.

The demodulating unit may include a parallel-to-serial converter converting a signal output from the fast Fourier transformer into a serial signal.

The receiver may further include a combining unit combining the demodulated signals with one another.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram showing an orthogonal frequency division multiplexing (OFDM) signal in a frequency domain;

FIGS. 2A through 2C are diagrams showing frequency arrangements of sub-carriers in an OFDM communications system;

FIG. 3 is a block diagram of an OFDM communications system according to an embodiment of the present invention;

FIGS. 4A through 4C are diagrams respectively showing a transmission signal in the OFDM communications system according to the embodiment of the present invention;

FIG. 5 is a conceptual diagram of the transmission signal according to the embodiment of the present invention; and

FIG. 6 is a conceptual diagram showing a plurality of division signals according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

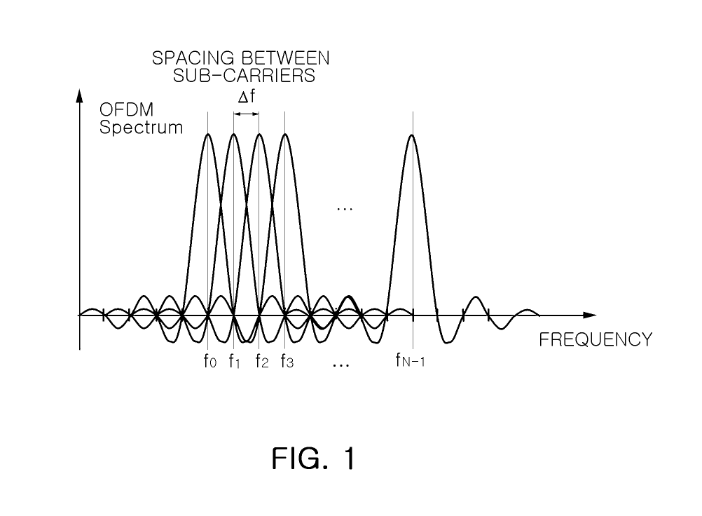

FIG. 1 is a diagram showing an orthogonal frequency division multiplexing (OFDM) signal in a frequency domain.

Referring to FIG. 1, a spectrum of sub-carriers that may be used in an OFDM system may be shown.

In OFDM, respective sub-carriers may be disposed at a spacing of ΔF. The center frequency of one sub-carrier may be f₁, and the center frequency of another sub-carrier may be f₂. Here, the spacing ΔF, a distance between f₁ and f₂ may be defined as a spacing between the sub-carriers. The sub-carriers may be orthogonal with regard to each other.

Meanwhile, due to the Doppler Effect in an environment in which a terminal moves, frequencies may not be arranged with a constant spacing therebetween in an OFDM scheme.

For example, in the case in which the terminal moves, the Doppler shift may be generated in a signal received from a transmitting end. In the OFDM scheme, since carriers are mapped to a frequency axis, in the case in which the Doppler shift is generated, a transmission frequency at a transmitting end and a reception frequency at a receiving end may be different from each other.

As a speed of the movement of the terminal is higher, the difference may be larger.

Meanwhile, since the Doppler Effect is generated in proportion to a frequency band, the larger Doppler shift may be generated in a sub-carrier in a high band rather than in a sub-carrier in a low band.

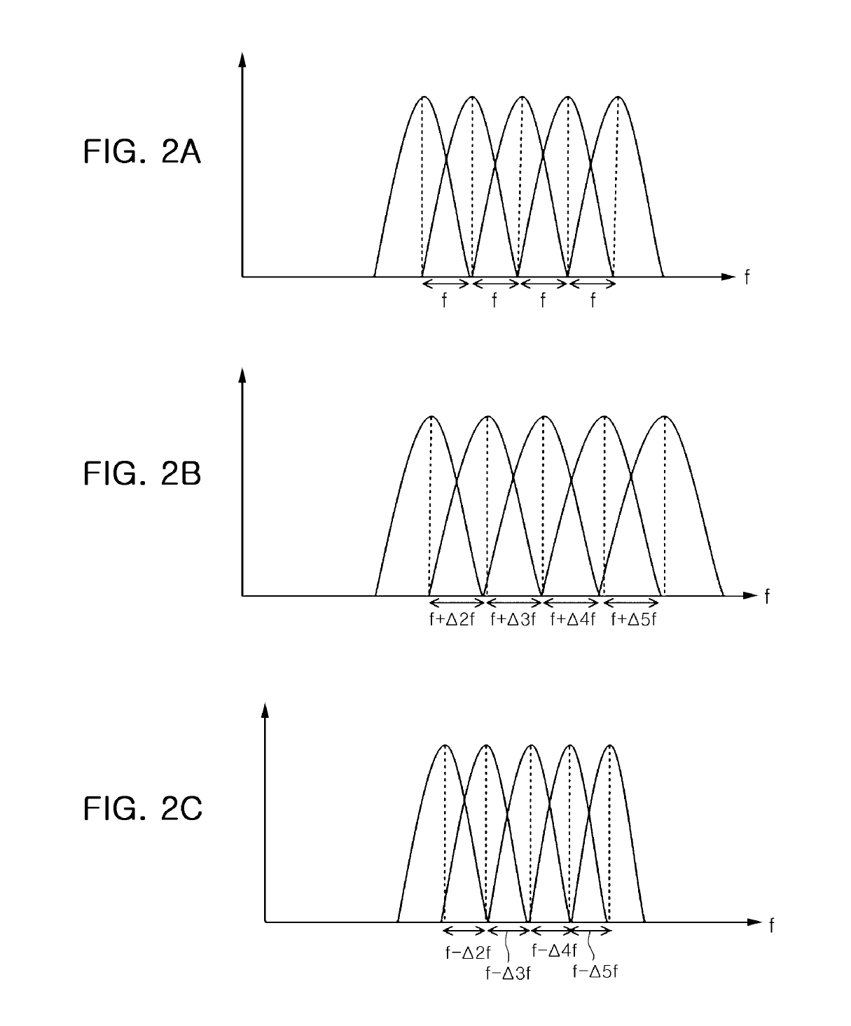

FIGS. 2A through 2C are diagrams showing frequency arrangements of sub-carriers in an OFDM communications system.

FIG. 2A is a diagram showing frequency arrangements of sub-carriers in the case in which the Doppler shift is not generated.

Referring to FIG. 2A, frequencies of the sub-carriers may be arranged such that the center frequencies of the subcarriers are spaced from one another by a spacing f.

FIG. 2B is a diagram showing a situation in which frequencies of sub-carriers are high due to the generation of the Doppler shift.

Referring to FIG. 2B, it may be confirmed that as the frequencies are high, a spacing between the respective sub-carriers gradually widens.

FIG. 2C is a diagram showing a situation in which frequencies of sub-carriers are low due to generation of the Doppler shift.

Also in this case, a spacing between the respective sub-carriers may not be maintained to be constant, similar to the case of FIG. 2B.

As described above, in the case in which the Doppler shift is generated in the respective sub-carriers in the OFDM communications system, inter-channel interference (ICI) may be generated due to an interference action between the sub-carriers.

In this case, deterioration in performance of the OFDM communications system may be generated.

Therefore, a configuration for preventing the deterioration in the performance of the OFDM communications system due to the Doppler Effect needs to be introduced.

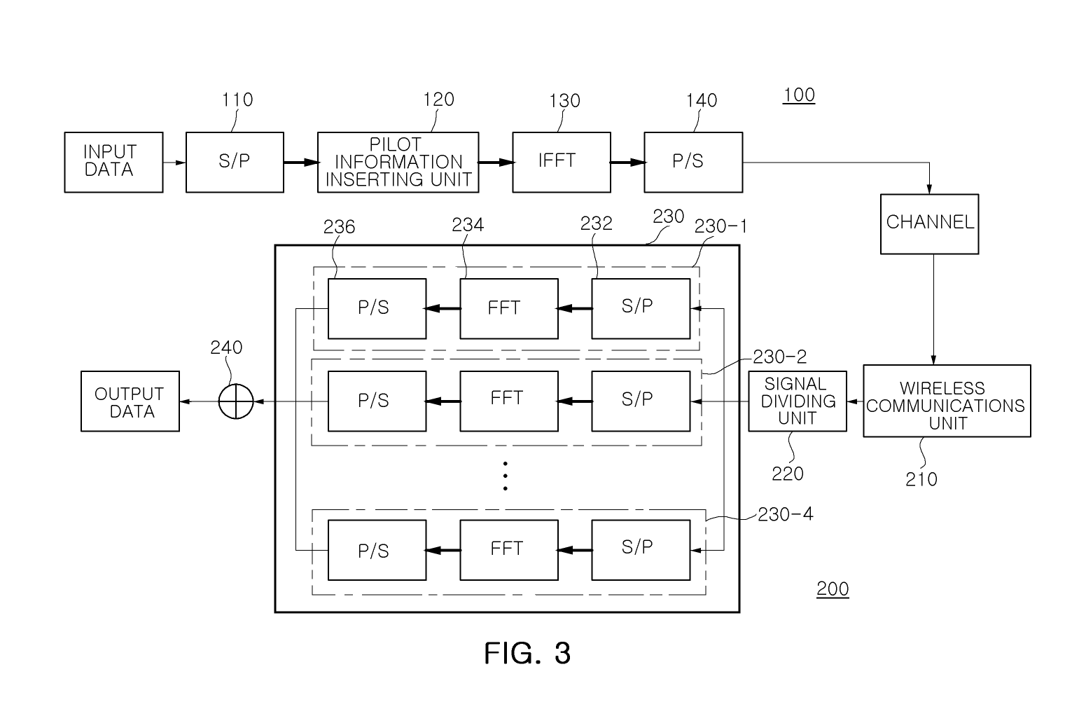

FIG. 3 is a block diagram of an OFDM communications system according to an embodiment of the present invention.

The OFDM communications system may include an OFDM transmitter 100 and an OFDM receiver 200.

The OFDM transmitter 100 may include a serial-to-parallel converting unit 110, a pilot information inserting unit 120, an inverse fast Fourier transform (IFFT) unit 130, and a parallel-to-serial converting unit 140.

The serial-to-parallel converting unit 110 may obtain data (wireless data information) to be wirelessly transmitted. In addition, the serial-to-parallel converting unit 110 may convert the wireless data information into a parallel signal.

The pilot information inserting unit 120 may add pilot information for measuring a frequency offset due to the Doppler shift to the wireless data information.

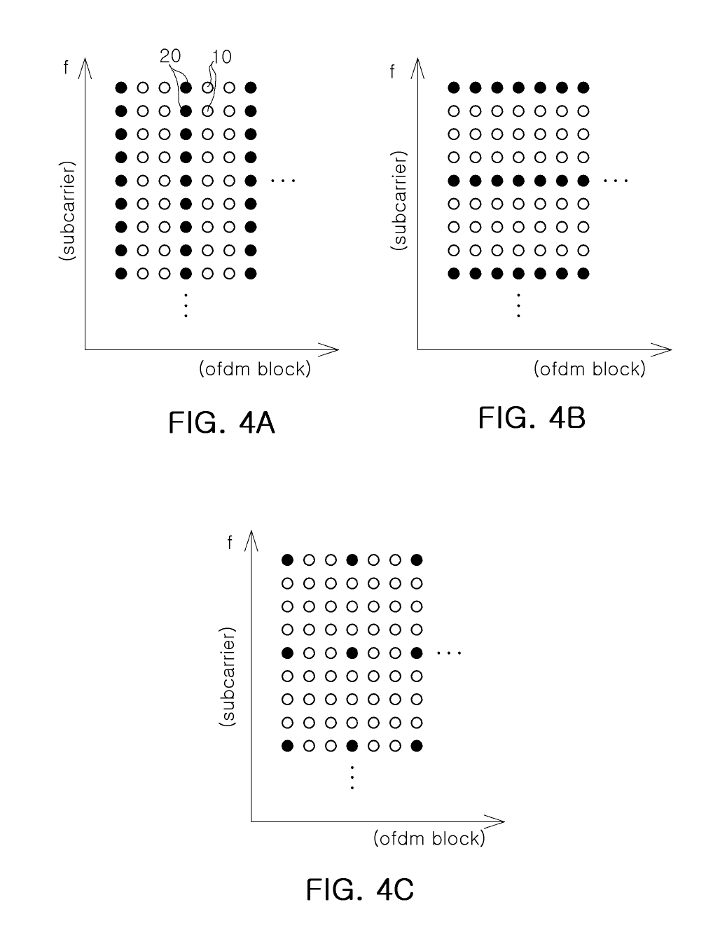

FIGS. 4A through 4C are diagrams respectively showing a transmission signal in the OFDM communications system according to the embodiment of the present invention.

Referring to FIGS. 4A through 4C, the transmission signal may include wireless data symbols 10 for information transmission and pilot symbols 20 for measuring a frequency offset due to the Doppler shift.

Respective transmission signals may have various types of pilot pattern according to transmission schemes and include the data symbols 10 and the pilot symbols 20 allocated in various schemes as shown in FIGS. 4A through 4C.

Each of the wireless data information converted into the parallel signal and the added pilot information may be allocated to the sub-carriers and be converted into a signal in a time domain through an inverse fast Fourier transform.

The inverse fast Fourier transform unit 130 may perform the inverse fast Fourier transform.

The parallel-to-serial converting unit 140 may convert a parallel signal output from the inverse fast Fourier transform unit 130 into a serial signal.

Meanwhile, the OFDM transmitter 100 may transmit the serial signal converted by the parallel-to-serial converting unit 140 to the OFDM receiver 200. Here, the signal transmitted from the OFDM transmitter 100 to the OFDM receiver is defined as a transmission signal. Meanwhile, the transmission signal may include the wireless data information and the pilot information.

The OFDM receiver 200 may receive the transmission signal via a predetermined channel.

The channel may be a multipath fading channel, and the transmission signal may be distorted by additive white Gaussian noise (AWGN) and then received in the OFDM receiver.

The OFDM receiver 200 may include a wireless communications unit 210, a signal dividing unit 220, a demodulating unit 230, and a combining unit 240.

The wireless communications unit 210 may receive the transmission signal including the wireless data information and the pilot information. In this case, the transmission signal may be in a state in which the frequency thereof is different from that of the transmission signal transmitted by the OFDM transmitter due to the Doppler Effect.

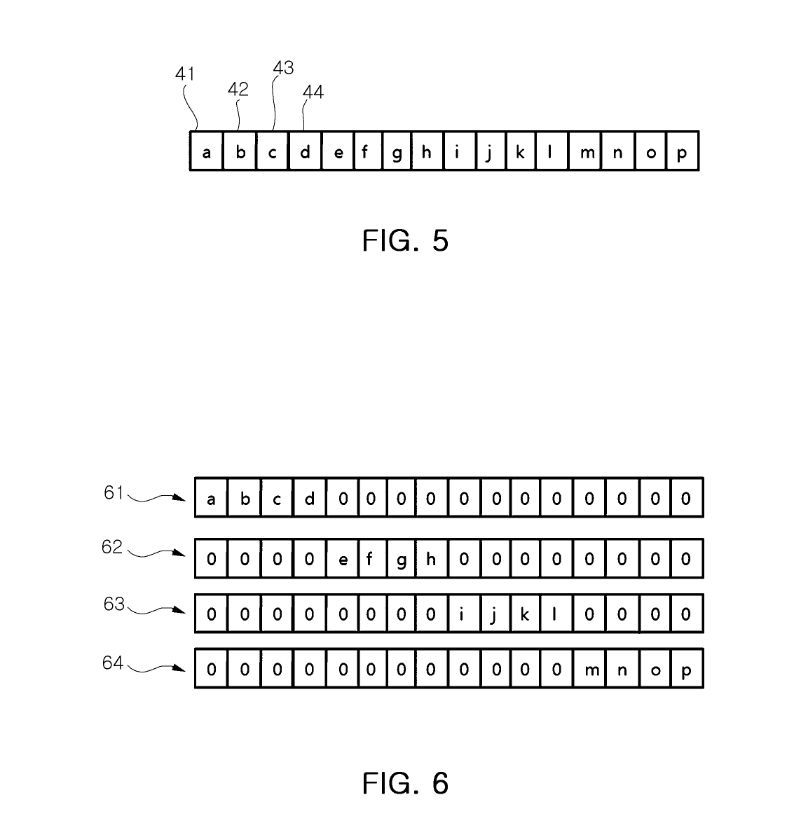

FIG. 5 is a conceptual diagram of the transmission signal according to the embodiment of the present invention.

Referring to FIG. 5, the transmission signal may include sixteen sub-carriers. A first sub-carrier 41 may include information ‘a’, a second sub-carrier 42 may include information ‘b’, a third sub-carrier 43 may include information ‘c’, and a fourth sub-carrier 44 may include information ‘d’. In the above-mentioned scheme, the respective sub-carriers may include predetermined information.

The signal dividing unit 220 may divide the transmission signal into a plurality of division signals.

FIG. 6 is a conceptual diagram showing the plurality of division signals according to the embodiment of the present invention.

For example, the signal dividing unit 220 may divide the transmission signal shown in FIG. 5 into four division signals.

Referring to FIG. 6, a first division signal 61 may include the first to fourth sub-carriers 41 to 44, and positions of remaining sub-carriers may be zero-padded with ‘0’. In addition, a second division signal 62 may include fifth to eighth sub-carriers, and positions of remaining sub-carriers may be zero-padded with ‘0’. Further, a third division signal 63 may include ninth and twelfth sub-carriers, and positions of remaining sub-carriers may be zero-padded with ‘0’. Further, a fourth division signal 64 may include thirteen to sixteen sub-carriers, and positions of remaining sub-carriers may be zero-padded with ‘0’.

In addition, the signal dividing unit 220 may obtain frequency offsets for the respective division signals based on the pilot information included in the transmission signal. The frequency offsets mean frequency error information generated due to the Doppler shift. In addition, the frequency offsets may include frequency error information on the respective division signals.

The demodulating unit 230 may demodulate the transmission signal based on the division signals and the frequency offsets. The demodulating unit 230 may include a plurality of demodulating units, each demodulating unit corresponding to each division signal. That is, the number of demodulating units 230 may correspond to the number of division signals divided by the signal dividing unit 220.

More specifically, the demodulating unit 230 may include a serial-to-parallel converter 232, a fast Fourier transformer 234, and a parallel-to-serial converter 236.

The serial-to-parallel converter 232 may convert one division signal into a parallel signal.

The fast Fourier transformer 234 may perform a fast Fourier transform on a single parallel signal from the serial-to-parallel converter 232 based on the frequency offsets.

Generally, in the fast Fourier transform at the receiving end of the OFDM, a center frequency f of a sub-carrier may be used in a fast Fourier transform equation.

Meanwhile, in the fast Fourier transformer 234 according to the embodiment of the present invention, frequency information based on the center frequency f of the sub-carrier and the frequency offset may be used in the fast Fourier transform equation, rather than the center frequency f of the sub-carrier.

For example, the center frequency f of the sub-carrier may be substituted with frequency information generated by summing the center frequency f of the sub-carrier and the frequency offset in the fast Fourier transform equation.

In a data transmitting process of the OFDM communications system, a frequency shift of the sub-carrier may be generated due to the Doppler shift. However, the frequency shift may be compensated for by the frequency offset.

According to the configuration described as above, inter-channel interference (ICI) due to the Doppler Effect may be significantly decreased. In addition, according to the configuration described as above, deterioration in the performance of the OFDM communications system may be prevented.

The parallel-to-serial converter 236 may convert a signal output from the fast Fourier transformer 234 into a serial signal.

According to the embodiment of the present invention, the demodulating unit 230 may be provided in plural and thus, a plurality of demodulating units 230-1, 230-2, and 230-4 may be provided. In addition, the serial-to-parallel converter 232, the fast Fourier transformer 234, and the parallel-to-serial converter 236 may be provided in plural.

In addition, when the number of demodulating units of the OFDM receiver 200 is increased, more accurate frequency correction may be enabled. The reason for this is that the number of demodulating units is increased, a frequency error due to the Doppler shift may be accurately compensated for by the frequency offset.

Meanwhile, the OFDM receiver according to the embodiment of the present invention may further include the combining unit 240 combining the plurality of demodulated signals with one another.

That is, the OFDM receiver 200 may obtain wireless data information through an output of the combining unit 240.

According to the embodiment of the present invention, the foregoing method may be implemented as a computer readable code in a medium on which a program is recorded. A computer readable medium may include all kinds of recording devices in which data that may be read by a computer system is stored. An example of the computer readable medium may include a read only memory (ROM), a random access memory (RAM), a compact disk read only memory (CD-ROM), a magnetic tape, a floppy disk, an optical data storage, or the like, and also include a medium implemented in a form of a carrier wave (for example, for transmission over the Internet). In addition, the computer may include a controlling unit for a communications device.

As set forth above, according to the embodiments of the present invention, the OFDM receiver and the OFDM communications system, capable of preventing deterioration in the performance of the OFDM communications system due to the Doppler Effect can be provided.

While the present invention has been shown and described in connection with the embodiments, it will be apparent to those skilled in the art that modifications and variations can be made without departing from the spirit and scope of the invention as defined by the appended claims.

What is claimed is:

1. An orthogonal frequency division multiplexing (OFDM) receiver comprising:
a wireless communications unit receiving a transmission signal including wireless data information and pilot information;
a signal dividing unit dividing the transmission signal into a plurality of division signals and obtaining frequency offsets for the respective division signals based on the pilot information included in the transmission signal; and
a demodulating unit demodulating the transmission signal based on the division signals and the frequency offsets.

2. The OFDM receiver of claim 1, wherein the demodulating unit includes a serial-to-parallel converter converting the division signals into parallel signals.

3. The OFDM receiver of claim 2, wherein the demodulating unit includes a fast Fourier transformer performing a fast Fourier transform on the parallel signals based on the frequency offsets.

4. The OFDM receiver of claim 3, wherein the demodulating unit includes a parallel-to-serial converter converting a signal output from the fast Fourier transformer into a serial signal.

5. The OFDM receiver of claim 1, further comprising a combining unit combining the demodulated signals with one another.

6. An OFMD communications system comprising:
a transmitter transmitting a transmission signal including wireless data information and pilot information; and
a receiver receiving the transmission signal,
wherein the receiver divides the transmission signal into a plurality of division signals and obtains frequency offsets for the respective division signals based on the pilot information included in the transmission signal.

7. The OFDM communications system of claim 6, wherein the receiver includes a demodulating unit demodulating the transmission signal based on the division signals and the frequency offsets.

8. The OFDM communications system of claim 7, wherein the demodulating unit includes a serial-to-parallel converter converting the division signals into parallel signals.

9. The OFDM communications system of claim 8, wherein the demodulating unit includes a fast Fourier transformer performing a fast Fourier transform on the parallel signals based on the frequency offsets.

10. The OFDM communications system of claim 9, wherein the demodulating unit includes a parallel-to-serial converter converting a signal output from the fast Fourier transformer into a serial signal.

11. The OFDM communications system of claim 7, wherein the receiver further includes a combining unit combining the demodulated signals with one another.
